(19) United States
(12) Patent Application Publication
(10) Pub. No.: US 2007/0222975 A1
(43) Pub. Date: Sep. 27, 2007

(54) TESTING METHOD FOR SURFACE DEFECTS ON DISC AND TESTING APPARATUS FOR THE SAME

(76) Inventors: SHIGERU SERIKAWA, Nakai (JP); Takayuki Ishiguro, Nakai (JP); Ryuta Suzuki, Nakai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/690,167

(22) Filed: Mar. 23, 2007

(30) Foreign Application Priority Data
Mar. 24, 2006 (JP) 2006-082113

(51) Int. Cl. G01N 21/88

(52) U.S. Cl. 356/237.2

(57) ABSTRACT

A testing method and a testing apparatus for surface detects on a disc, wherein a testing position is provided within an outside of a front surface disc cassette, the disc, which is stored in said disc cassette, is pushed out in front of the disc cassette from a bottom surface of the disc cassette, said disc, which is pushed out in the front, is moved up to the testing position, while holding it, and scanning is made on the disc by a laser beam while moving front/back the disc into direction of pushing out the disc held, at the testing position.

### BACKGROUND OF THE INVENTION

The present invention relates to a testing method for surface defects on a disc and a testing apparatus and in more details, it relates to a testing method for surface defects on a disc and a testing apparatus, enabling to shorten handling time of the disc in testing of concave-convex detects or adhering foreign matters on the surface of a magnetic disc or a substrate thereof, in particular, thereby improving throughput of disc inspection or testing.

In recent years, a magnetic disc, which is to be used as an information recording medium for a computer or the like, is required to be higher, in the memory density thereof, more and more, and it is also made small in the sizes thereof.

As an example of manufacturing method, in particular, of such the magnetic disc of using a glass disc, first of all, the glass disc is lapped by a lap machine (i.e., a lapping process), and then polishing process is made on both surface of the glass disc, so as to have a mirror surface of an averaged surface roughness of about 1 nm (i.e., a polishing process). Thereafter, cleaning is made on the glass substrate (i.e., a first cleaning process), and a surface defect testing and a peripheral surface defect testing are conducted (i.e., a first surface testing process). And then, cleaning is made on the glass substrate, which passes the testing (i.e., a second cleaning process), and a metal foundation film or layer is formed of chromium, copper and NiAl, etc., with thickness of about 50 to 200 Å (i.e., a metal foundation layer forming process), through the spattering method. Following to the above, also through the spattering method or the like, a magnetic film or layer is formed of a ferromagnetic alloy, such as, of a group of cobalt, with thickness of bout 100 to 1,000 Å (i.e., a ferromagnetic layer forming process), and further a protection film or layer is formed thereon, being made of a carbon film, a carbon hydride film or a carbon nitride film, etc., for example, with thickness of about 10 to 150 Å (i.e., a protection layer forming process). After forming the protection film through such manufacturing process, for the purpose of removing small projections, which are generated during the film forming process and also cleaning the surface thereof, a tape cleaning or the like is conducted upon the surface of the magnetic disc, by means of a grinding attachment (i.e., a vanishing and wiping process), and at the last, again, the surface testing is conducted (i.e., a second surface testing process).

By the way, upon testing on a display panel, etc., the defect testing is conducted through XY scanning while mounting a panel on a XY testing stage. However, since the disc has a disc-like configuration, therefore in normal, the disc is attached on a spindle during the first surface testing process and/or the second surface testing process, and the defect testing is conducted by spirally scanning a laser beam on the disc (Patent Document Nos. 1 and 2).

At present, use of the hard disc is spread into fields of automotive appliances and/or home appliances, as well as, audio appliances, and there are normally used hard disc drives (HDD) having sizes from 2.5 inch to 1.8 inch, and further that being equal or less than 1.0 inch, such as, 0.85 inch, for example, i.e., the HDD itself comes to be smaller.

Patent Document No. 1: Japanese Patent Laying-Open No. Hei 5-120677 (1993); and

Patent Document No. 2: Japanese Patent Laying-Open No. 2003-050209 (2003).

### BRIEF SUMMARY OF THE INVENTION

Thus, production of HDD increases, sharply, accompanying with rapid advancing of installation of HDD into the home appliances and/or the automotive appliances, however the testing on the disc cannot follow it, fitting with that increase. Further, upon testing the projection or the concave-convex on the surface of the magnetic disc and/or the substrate thereof, from a viewpoint of request for high recording density, it is required to detect the projection and the concave defect much lower than before, and for that reason, it takes more time for the detection thereof. For this reason, it is tried or attempted to align plural pieces of the testing apparatuses in parallel, increasing the number thereof, for example, however this brings about the problem of pushes up the manufacturing costs of HDD high.

From such the viewpoint, upon testing on the disc through the spiral scanning method, a ratio of time comes to be relatively high, being occupied by a handling process, i.e., for loading or inserting the disc on the spindle and for taking out it therefrom, comparing to the entire time, which is inherently occupied by testing, and thereby lowering efficiency on the disc testing.

An object, according to the present invention, for dissolving such the problems of the conventional arts, is to provide a testing method for surface defects on a disc and a testing apparatus, enabling to shorten handling time of the disc in testing of concave-convex detects or adhering foreign matters on the surface of a magnetic disc or a substrate thereof, thereby improving throughput of disc inspection or testing.

For accomplishing the objection mentioned above, according to the present invention, there are provided a testing method and a testing apparatus for surface detects on a disc, wherein a testing position is provided within an outside of a front surface disc cassette, the disc, which is stored in said disc cassette is pushed out in front of the disc cassette from a bottom surface of the disc cassette, said disc, which is pushed out in the front, is moved up to the testing position, while holding it, and scanning is made on the disc by a laser beam while moving front/back the disc into direction of pushing out the disc held, at the testing position.

According to the present invention, the disc stored in the disc cassette is pushed out in front of the disc cassette from the bottom surface of the disc cassette, and the disc is transferred up to the testing poison provided outside the disc cassette, in the vicinity thereof, wherein the disc set at the testing position is scanned by a light beam while moving the disc front and back, as it is, with respect to the disc cassette, and thereby conducting the defect test on that disc.

According to the present invention, the testing position is located outside of the disc cassette in front thereof, so that the disc, being a target of testing, can be set at the testing position only by pushing it out; therefore, there is no necessity of providing a special test stage and/or a spindle for loading the disc, and it is also possible to shorten the time-period for handling process, during the time from the disc testing up to the end of testing.

As a result thereof, it is possible to achieve an improvement on the throughput for testing, within the testing upon the entire of the disc.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a system view for showing a defect testing apparatus applying a surface defect testing method for a disc, mainly around an optic system thereof, according to an embodiment of the present invention;

FIG. 2 is a side view for explaining a disc pushup mechanism for pushing up a disc from a disc holding cassette to set it at a testing position;

FIGS. 3(a) and 3(b) are views for explaining the pushing up operation of the disc pushup mechanism; and

FIGS. 4(a) and 4(b) are views for explaining a relationship between the disc cassette and an up/down movable pushup arm.

### DETAILED DESCRIPTION OF THE INVENTION

Hereinafter, embodiments according to the present invention will be fully explained by referring to the attached drawings.

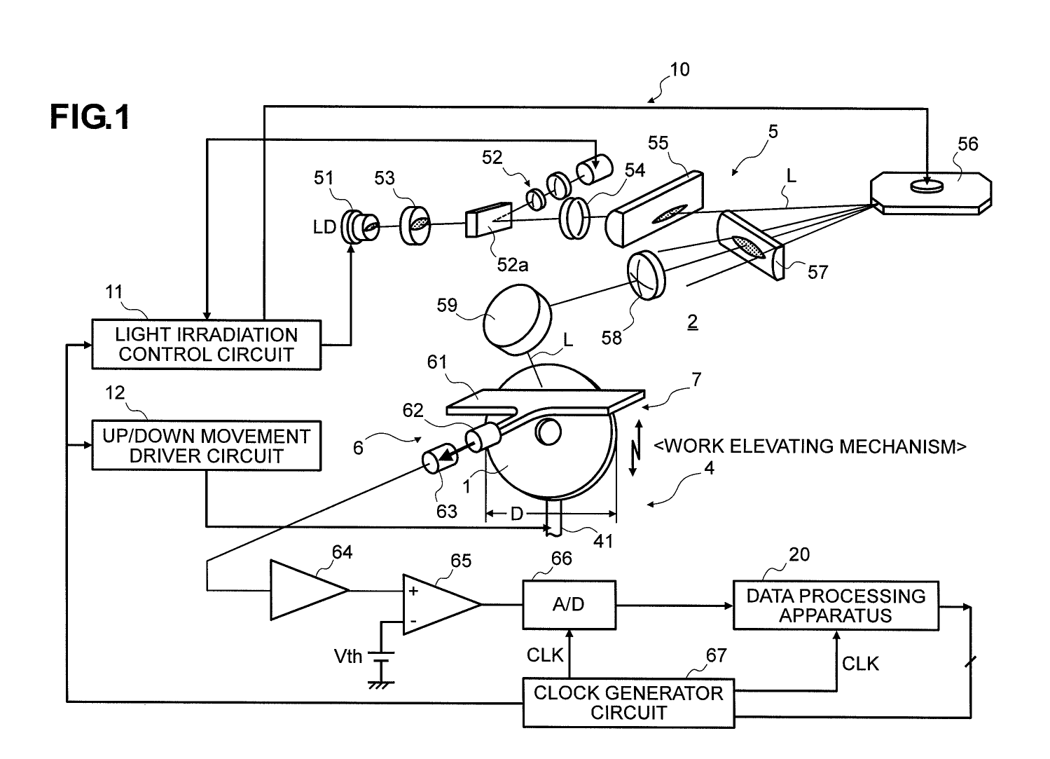

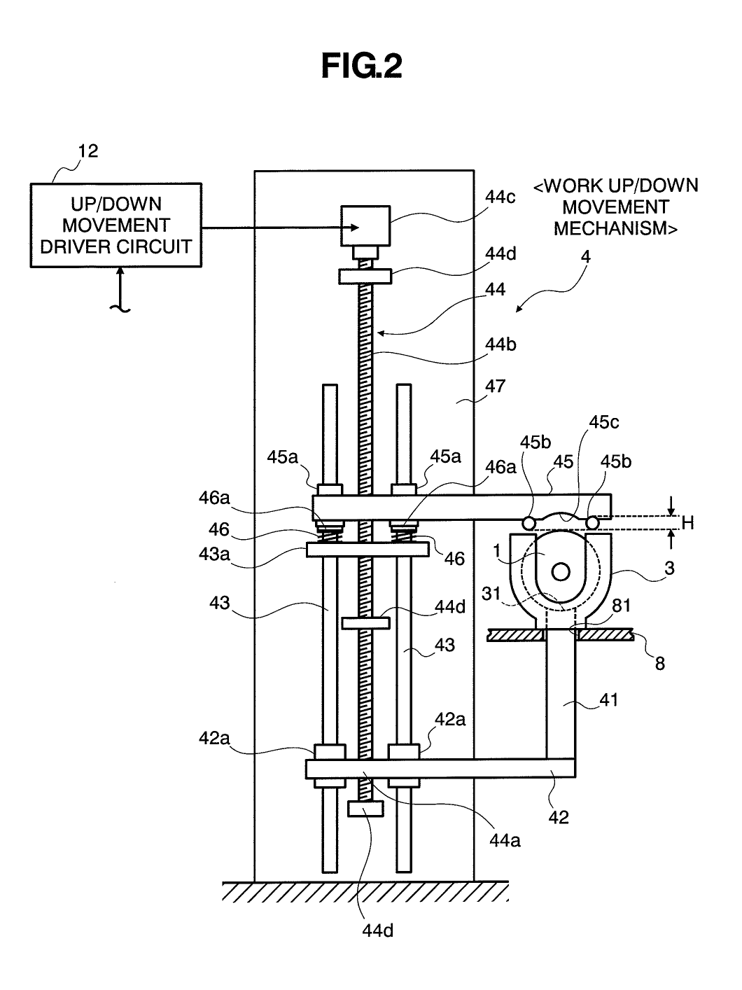

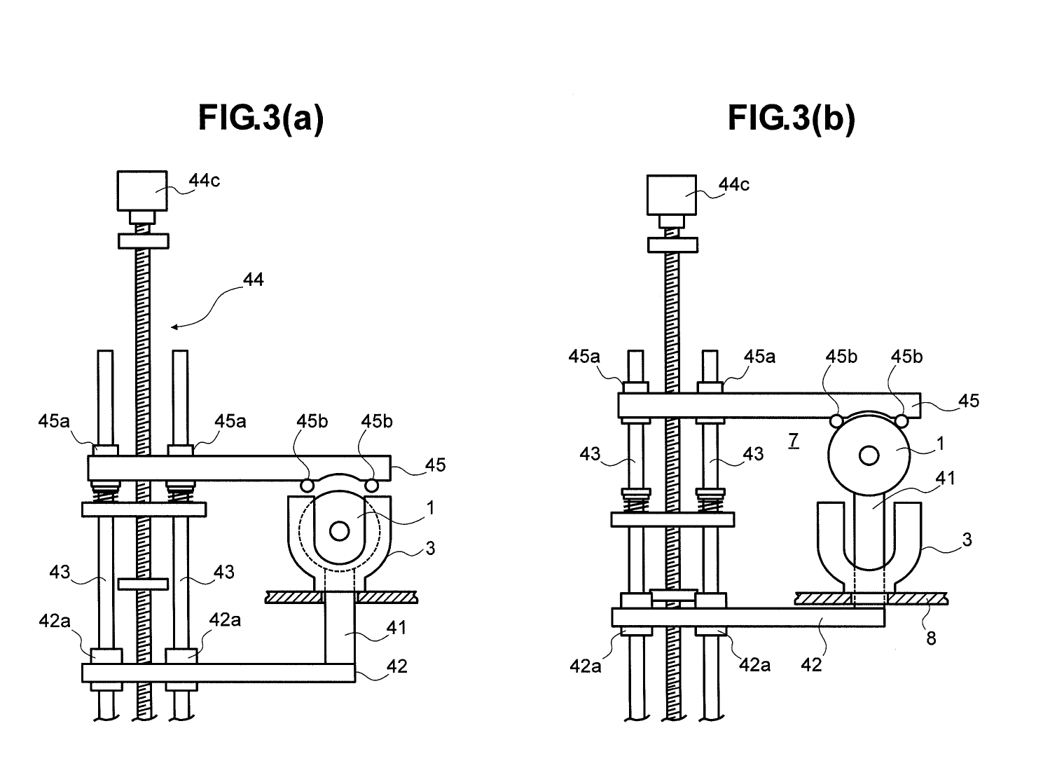

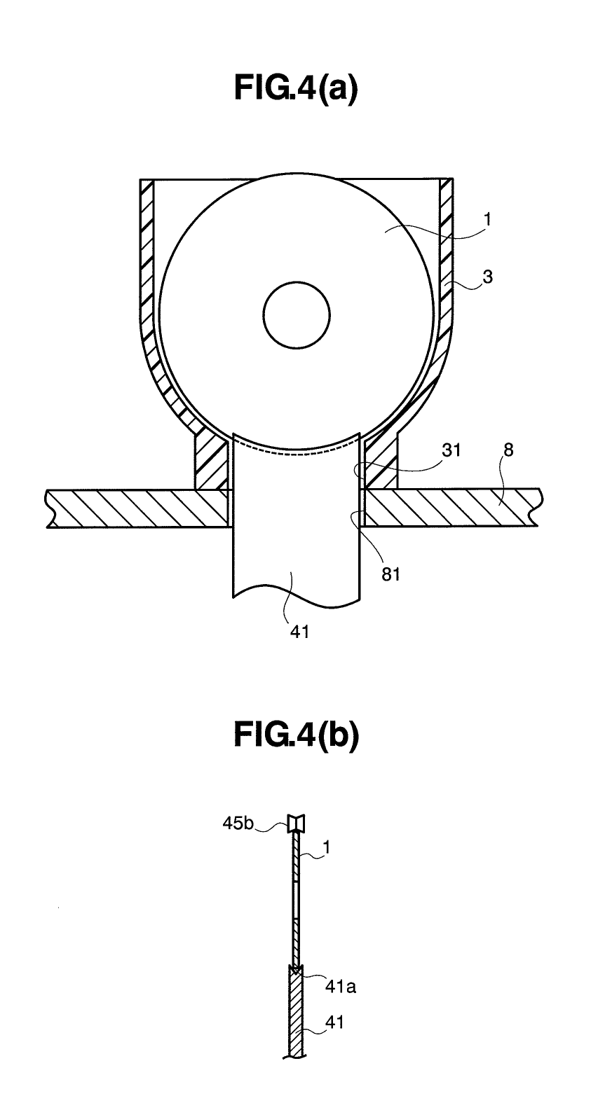

FIG. 1 is a system view for showing a defect testing apparatus applying a surface defect testing method for a disc, mainly around an optic system thereof, according to an embodiment of the present invention; FIG. 2 is a side view for explaining a disc pushup mechanism for pushing up a disc from a disc holding cassette to set it at a testing position; FIGS. 3(a) and 3(b) are views for explaining the pushing up operation of the disc pushup mechanism; and FIGS. 4(a) and 4(b) are views for explaining a relationship between the disc cassette and an up/down movable pushup arm.

In FIG. 1, a reference numeral 10 depicts the defect testing apparatus, 1 depicts a disc to be an object of that testing (i.e., a magnetic disc or a substrate thereof, and hereinafter, being called “disc”), and 2 depicts an optical system for defect detecting within the defect testing apparatus 10.

The disc 1, being pushed up from a disc cassette 3 by means of an up/down movable pushup arm 41 of a work up/down movement mechanism 4 (see FIG. 2), is held and set it at a test position 7 (i.e., a test starting position), and is conducted with XZ scanning by a laser beam.

The defect detecting optical system 2 comprises a light projection system 5 and a light receiving system 6 on a testing surface side of the disc 1.

The light projection system 5 comprises a laser light source 51 for generating a laser beam “L” with an aid of a semiconductor laser element (LD), and a monitoring mechanism 52 for use of adjusting an output thereof.

The laser beam generated from the laser light source 51, passes through a compensation lens 53 and also a mirror 52a of the monitoring mechanism 52 for use of adjusting an output thereof, which is disposed at an angel 45°, and the beam transmitting through them further passes through a collimator lens 54 and a semi-cylindrical lens 55 for use of lighting, to be irradiated upon a concave mirror 59 through a polygon mirror 56, a semi-cylindrical lens 57 and a lens 58.

Further, a portion reflected upon the mirror 52a of the monitoring mechanism 52 is transmitted to the monitor side, so that an output of the laser light source 51 is adjusted through a light irradiation control circuit 11.

Through control on rotation of the polygon mirror 56, the laser beam “L” irradiated upon the disc 1 is swung into one direction (i.e., from the left to the right) within a region covering width of an outer diameter “D” of the disc 1 in the “X” axis direction, thereby scanning the disc 1.

A light reflecting from the disc 1 is received, by means of the light receiving system 6. Within the light receiving system 6, the light is condensed by means of a bundle 62 of optical fibers 61, which are aligned on a line in the X direction, and it is applied onto a light-receiving element 63. As such the light-receiving element 63 may be used a photoelectric conversion element, such as, a PMT (i.e., a photo multiplier) or an APD (i.e., an avalanche photodiode), etc.

The disc 1 is pushed out forwards from the disc cassette 3 through the work up/down movement mechanism 4, and further is set at the testing position 7, to be moved vertically, i.e., into the “Z” direction herein.

In this embodiment, the work up/down movement mechanism 4 having the up/down movable pushup arm 41 shares functions of the pushup mechanism and the up/down disc movement mechanism of the present invention.

Due to rotation of the polygon mirror 56, the light beam scans the disc 1 into the “X” axis direction, and the work up/down movement mechanism 4 moves the disc into the “Z” direction. With this, scanning is made on the whole surface of the disc 1 in XZ directions.

The reflection lights obtained from the surface of the disc 1 through this XZ scanning, respectively, when irradiating the laser beam thereon, is received by the light receiving system 6 defining a light receiving angle (i.e., an elevation angle) of about 60°-70° with respect to the surface of the disc 1. And, the lights are collected by means of the bundle 61 of optical fibers 62, and the collected lights are applied onto that light receiving element 63. With this, the lights received are converted into an electric signal.

As a result thereof, a detection signal is outputted from the light receiving element 63, depending on the amount or volume of the lights received. Voltage of this detection signal is inputted to a preamplifier 64 as a detection voltage, and an amplifier 65 generates a detection signal removing noises depending on a threshold value “Vth”, responding to the timing for controlling the drive of the laser light source of the light irradiation control circuit 11. This detection signal is sampled within an A/D converter circuit (A/D) 66. Sampling timing within the A/D 66 is determined by receiving a clock “CLK” from a clock generator circuit 67. An output of the A/D 66, after being added with a scanning position coordinate in the “Z” direction of the disc by the work up/down movement mechanism 4, is processed within a data processing apparatus 20, and thereby detecting the defects.

However, the A/D 66 is controlled by means of the data processing apparatus 20, in the similar manner to the light irradiation control circuit 11, corresponding to a region (i.e., a detection cell) to be detected, which is set on the disc 1.

Also, the work up/down movement mechanism 4 is controlled in the vertical movement thereof by means of the data processing apparatus 20, through an up/down movement drive circuit 12.

FIG. 2 is a view for explaining the work up/down movement mechanism 4, and it shows the condition that the disc cassette 3 receiving a large number of discs 1 aligning therein is set at a load/unload position on the testing table 8. A head portion of the up/down movable pushup arm 41 of the work up/down movement mechanism 4 is located just below there verse surface of the testing table 8, at this time.

When the disc cassette 3 is loaded on the testing table 8, it is positioned by a handling robot (not shown in the figure) at such a position that the disc 1 at a front portion of those received within the disc cassette 3 is located at a lift portion on a upper part of the up/down movable pushup arm 41.

The disc cassette 3 is disposed horizontally on the testing table 8, and the testing table 8 moves into the direction vertical or perpendicular to the paper surface of this drawing.

The up/down movable pushup arm 41 penetrates through an opening portion 81 of the testing table 8 from a bottom opening 31 of the disc cassette 3 (see FIG. 4) to an upper part thereof (see FIGS. 3(a) and 3(b)). The root or basement of the up/down movable pushup arm 41 at the lower side is fixed on a tip portion of a lift rod 42 extending into the horizontal direction.

The lift rod 42 projects into the horizontal direction, and the basement end portion at the opposite side thereof is connected to guide rails 43 and 43, being up/down movable through slide bearings 42a and 42a, and thereby being supported on the guide rails 43 and 43, under the condition of being supported on one side (i.e., cantilever-like).

The guide rails 43 and 43 are fixed onto a base frame 47, respectively, through a bracket 43a, which is provided on a way, in an upper part of the lift rod 42.

The portion of the lift rod 42 between the slide bearings 42a and 42a builds up a nut portion 44a of a ball and nut mechanism 44, and the lift rod 42 moves up and down through the rotation of the screw portion 44b of the ball and nut mechanism 44, which is driven by a motor 44c. Then, the up/down movable pushup arm 41 moves up and down or vertically.

At a lower side in front of the motor 44c, as well as, at an upper and lower portions of the nut portion 44a are provided three (3) pieces of brackets 44d, 44d and 44d for fixing them onto a base frame 47 in a movable manner. Of course, the motor 44c is fixed onto the base frame 47.

On the upper part of the bracket 43a for fixing the guide rails 43 and 43 onto the base frame 47 is provided a disc receiving arm 45 projecting into the horizontal direction in parallel with the lift rod 42, so that it faces to the lift rod 42.

The disc receiving arm 45 is connected onto the guide rails 43 and 43, through slide bearings 45a and 45a, at the basement end portion thereof, being movable up and down or vertically, and held on one side thereof.

At a tip side of the disc receiving arm 45 are provided chuck rollers 45b and 45b separated at a predetermined distance therebetween, corresponding to an opened front surface of the disc cassette 3. Between the chuck rollers 45b and 45b is provided a cutoff portion 45c, being wound or curved corresponding to an outer configuration of the disc 1, thereby preparing a gateway, on which an outer periphery of the disc 1 is in contact with.

Between the bracket 43a and the disc receiving arm 45, springs 46 and 46 and washers 46a and 46a provided thereon are inserted into the guide rails 43 and 43, respectively. Supporting the disc receiving arm 45 through those springs 46 and 46 and washers 46a and 46a enables to set an initial height of the disc receiving arm 45 at a constant value, and to set a position where the chuck rollers 45band 45bengage with the disc 1, at the position separated from the upper part of the disc cassette 3 at a constant distance “H” (for example, 3 to 8 mm, approximately). The tip of the chuck roller 45b and 45b and an apex on the outer periphery of the disc 1 are substantially equal to in the height. In other words, the disc (the apex thereof) is stored within the disc cassette 3, but coming out a little portion thereof from the upper part thereof.

Within the structures of the guide rails 43 and 43 and the ball and nut mechanism 44, etc., herein is built up an up/down movement mechanism of the lift rod 42. This up/down movement mechanism builds up a movement mechanism common with the up/down movable pushup arm 41 and the disc-receiving arm 45, and this serves both the disc pushup mechanism and the disc front/back movement mechanism according to the present invention.

Next, explanation will be given on the disc push-out operation and disc front/back movement operation, by referring to FIGS. 3(a) and 3(b).

FIG. 3(a) is a view for explaining the condition when pushing up the disc 1 locating at the lift position of the disc cassette 3 through driving of the work up/down movement mechanism 4, and FIG. 3(b) shows the condition where the disc is set at the testing position 7 through driving of the work up/down movement mechanism 4, wherein the disc up/down movement (i.e., movement in the “Z” direction corresponding to the front/back movement) is carried out at this testing position 7.

First of all, driving is started with controlling the rotation of the motor 44c by the up/down movement drive circuit 12. When the motor 44c is driven, so as to rise up the lift rod 42, the outer periphery of the disc 1 comes in contact with the chuck roller 45b and 45b, i.e., in the condition of being chucked at three (3) points between the up/down movable pushup arm 41, and the disc 1 is pushed out, to be held. This condition is shown in FIG. 3(a).

When the lift rod 42 goes up further, also the disc receiving art 45 goes up with elevation of the lift rod 42, while holding the disc 1 through the disc 1, and at the time when the lift rod 42 goes up by a predetermined amount (depending on the diameter of the disc, but for example, 70-90 mm, approximately), the disc 1 is set at the testing position, as is shown in FIG. 3(b).

However, herein, chucking is conducted with the disc receiving art 45, and the chucking force applied on the outer periphery of the disc 1 is determined by the deadweight of the disc receiving art 45, with using the gravity. FIG. 1 shows the condition of the disc 1, being held at the testing position 7 under this condition.

At this testing position 7, driving of the motor 44c through the up/down movement drive circuit 12 moves the disc 1 by a distance of D+α (D: the diameter of the disc 1), and further, driving upwards the lift rod 42 at a predetermined speed moves the disc 1 into the “Z” direction by the distance of D+α. With this, scanning can be made on the disc 1 by the light beam, into the “Z” direction in addition to the “X” direction, due to rotation of the polygon mirror 56.

Next, when the up/down movement drive circuit 12 rotates the motor 44c into the reserve direction, the lift rod 42 goes down, and the disc receiving art 45 follows it due to the gravity thereof, wherein the disc 1 falls down, while being held between them. Then, the lift rod 42 is turned back to the original testing position 7 at the predetermined speed, lowering down by distance of D+α (D: the diameter of the disc 1). With this, scanning can be made on the disc 1 in the “X” direction due to the rotation of the polygon mirror 56, in addition into the “Z” direction, but opposite to the abovementioned direction.

With repetition of such the operation, the scanning is made on the disc 1 in the “XZ” directions, and reciprocating movement in the “Z” direction herein builds up the disc front/back movement mechanism.

However, the data processing apparatus 20 comprises a processor, a memory, and interface, etc., where in control programs for the disc push-out operation and the disc front/back movement operation, which are stored within the memory, are executed by the processor, thereby achieving the operations of pushing-out and up/down moving of the disc 1 mentioned above.

When completing the testing upon the entire surface of the disc 1, the lift rod 42 falls down, to come back into the condition shown in FIG. 3(a), and it further falls down into the condition shown in FIG. 2, wherein a tip of the up/down movable pushup arm 41 is located below the bottom surface of the disc cassette 3. Herein, the testing table 8 is shifted in front on the paper surface of the drawing, by the distance aligning the discs, so that the next disc 1 is set at the lift position on the upper part of the up/down movable pushup arm 41.

Next, the disc 1 comes into the condition shown in FIG. 3(a) from the condition shown in FIG. 2, and through this, it enters into testing under the condition shown in FIG. 3(b), and after completing the testing, it turns back to the condition shown in FIG. 2 through the condition shown in FIG. 3(a). Hereinafter, with repeating the similar processing, testing is made on the discs 1 stored within the disc cassette 3, sequentially.

When testing is completed on all of the discs stored within the disc cassette 3, for example, 24 pieces of discs, the disc cassette 3 shown in FIG. 2 is unloaded by means of the handling robot (not shown in the figure), and then the next disc cassette 3 is set into the condition as shown in FIG. 2.

FIG. 4 is a view for explaining the relationship between the disc cassette and the up/down movable pushup arm 41 of the work up/down movement mechanism 4.

The disc cassette 3, as is shown on the cross-section view in FIG. 4(a), comprises a bottom opening 31, and is opened in the upper part thereof, and it holds the discs 1, while aligning them therein.

The up/down movable pushup arm 41 enters into the bottom opening 31 through an opening portion 81 of the testing table 8, and it engaged with the disc 1 on the lower periphery thereof.

Pushup of the disc 1 by means of the tip of the up/down movable pushup arm 41 is conducted, as is shown on the cross-section view in FIG. 4(b), by engaging the outer periphery of the disc 1 into a shallow “V” gutter 41a, which is provided at the tip of the up/down movable pushup arm 41.

With this, when the up/down movable pushup arm 41 goes up by the distance “H”, the disc 1 is held between the tip of the up/down movable pushup arm 41 and the chuck rollers 45b and 45b of the disc receiving art 45.

However, even if the “V” gutter 41a is shallow, the disc 1 will not fall down, since it is engaged with an aligning guide groove (not shown in the figure), which is provided on a side wall surface of the disc cassette 3, during the process of elevation, and it can goes up, vertically, by distance “H”. In case of the disc cassette 3 wherein the disc may falls down, it is sufficient to make the distance “H” small, or to let the disc receiving art 45 to fall into direction of the disc 1.

The reason for making the “V” gutter 41a shallow, which is provided at the tip of the up/down movable pushup arm 41, is in the order to make an untested region small on the disc. Accordingly, in case when falling the disc receiving art 45 down into direction of the disc 1, there is no necessity of building up the “V” gutter 41a into such the gutter, but it may be made only into a concave portion.

As was mentioned in the above, according to the present embodiment, the up/down movable pushup arm 41 and the disc receiving art 45 are made up with the common movement mechanism, however it is of course, in the place thereof, the up/down movement mechanism may be provided for the disc push-out mechanism and the disc front/back movement mechanism, respectively, in the structures thereof, so that the disc held by the disc push-out mechanism is delivered to the disc front/back movement mechanism.

Also, in the embodiment, there is provided a light receiver of using the optical fibers, as the light receiving system, however this should not be limited to the light receiver using the optical fibers, but may be applied any one of various kinds of light receiving elements or light receivers, including, such as, an image sensor, etc.

Further, according to the embodiment, a laser spot is irradiated upon the testing region on the disc with using the laser light source, however the present invention should not be restricted only to such the spot of the laser, but it is of course, to apply a light beam, in general, in the place thereof.

Further, in this specification is used the word “defect(s)” with an intention to include a wide idea or concept for a general fault on the disc, but not only an adhering foreign matter, a stain, a loss or a default, and this is also true for the words used within the pending claims.

While we have shown and described several embodiments in accordance with our invention, it should be understood that disclosed embodiments are susceptible of changes and modifications without departing from the scope of the invention. Therefore, we don not intend to be bound by the details shown and described herein but intend to cover all such changes and modifications that fall within the ambit of the appended claims.

What is claimed is:

1. A testing method for surface detects on a disc, comprising the following steps of:
taking out a disc from a disc cassette, which is opened in a front surface thereof;
transferring said disc taken out to a testing position; and
irradiating a light beam upon said disc, thereby testing the surface defects on the disc, further comprising:
providing said testing position within an outside of a front surface disc cassette;
pushing out said disc, which is stored in said disc cassette, in front of said disc cassette from a bottom surface of said disc cassette;
moving said disc, which is pushed out in the front, up to said testing position, while holding it; and
scanning on said disc by a light beam while moving front/back said disc into direction of pushing out said disc held, at said testing position.

2. The testing method for surface detects on a disc, as described in the claim 1, wherein there are further provided a disc push-out arm for pushing out said disc into direction vertical to said disc cassette, being engaged on an outer periphery of said disc, and a disc receiving arm, provided outside in front of disc cassette opposing to said disc push-out arm, wherein said disc pushed out in front is transferred to said testing position, while being held between said disc push-out arm and said disc receiving arm, and said disc held therebetween is moved front/back through front/back movement of said disc push-out arm and said disc receiving arm into said vertical direction, at said testing position.

3. The testing method for surface detects on a disc, as described in the claim 2, wherein said disc cassette is disposed on a testing table in horizontal direction, said disc push-out arm moves up and down in vertical direction, and said disc receiving arm moves up and down due to deal load thereof, responding to up and down movement of said disc push-out arm, through said disk.

4. The testing method for surface detects on a disc, as described in the claim 3, wherein on said disc receiving arm is provided a roller to be engaged on the outer periphery of said disc, and said disk push-out arm is connected with an up/down movement mechanism, to push out said disc in front, so that said roller is engaged with said disc on the outer periphery thereof, thereby holding said disc, and this disc held is transferred to said testing position and further the front/back movement of said disc in said direction of being pushed out is conducted by said up/down movement mechanism.

5. A testing apparatus for surface detects on a disc, comprising:
a portion which is configured to take out a disc from a disc cassette, which is opened in a front surface thereof;
a portion which is configured to transfer said disc taken out to a testing position; and
a portion which is configured to irradiate a light beam upon said disc, thereby testing the surface defects on the disc, further comprising:
a disc push-out mechanism, providing said testing position within an outside of a front surface disc cassette, for pushing out said disc, which is stored in said disc cassette, in front of said disc cassette from a bottom surface of said disc cassette, and for moving said disc, which is pushed out in the front, up to said testing position, while holding it; and
a portion which is configured to scan on said disc by a light beam while moving front/back said disc into direction of pushing out said disc held, at said testing position.

6. The testing apparatus for surface detects on a disc, as described in the claim 5, wherein said disc push-out mechanism further comprises: a disc push-out arm which is configured to push out said disc into direction vertical to said disc cassette, being engaged on an outer periphery of said disc; a disc receiving arm, provided outside in front of disc cassette opposing to said disc push-out arm; and a movement mechanism which is configured to move said disc push-out arm and said disc receiving arm, wherein said disc pushed out in front is transferred to said testing position, while being held between said disc push-out arm and said disc receiving arm, further comprises
a disc front/back movement mechanism which is configured to move said disc push-out arm and said disc receiving arm front and back by controlling said movement mechanism of said disc push-out mechanism, thereby moving said disc front and back.

7. The testing apparatus for surface detects on a disc, as described in the claim 6, wherein said disc cassette is disposed on a testing table in horizontal direction, said disc push-out arm moves up and down in vertical direction, and said disc receiving arm moves up and down due to deal load thereof, responding to up and down movement of said disc push-out arm, through said disk.

8. The testing apparatus for surface detects on a disc, as described in the claim 7, wherein on said disc receiving arm is provided a roller to be engaged on the outer periphery of said disc, and said disk push-out arm is connected with an up/down movement mechanism, to push out said disc in front, so that said roller is engaged with said disc on the outer periphery thereof, thereby holding said disc, and this disc held is transferred to said testing position and further the front/back movement of said disc in said direction of being pushed out is conducted by said up/down movement mechanism.
